(19) United States
(12) Patent Application Publication
(10) Pub. No.: US 2003/0076577 A1
(43) Pub. Date: Apr. 24, 2003

(54) LOSSLESS OPTICAL TRANSMISSION LINK

(76) Inventors: Vincent G. Dominic, Fremont, CA (US); David F. Welch, Menlo Park, CA (US); Robert G. Waarts, Los Altos, CA (US); Stuart MacCormack, Mountain View, CA (US); Mehrdad Ziari, Pleasanton, CA (US); Robert J. Lang, Pleasanton, CA (US); Donald R. Scifres, San Jose, CA (US)

Correspondence Address: Christopher F. Regan, Allen, Dyer, Doppelt, Milbrath & Gilchrist, P.A., P.O. Box 3791, Orlando, FL, 32802-3791, US

(21) Appl. No.: 09/746,084

(22) Filed: Dec. 22, 2000

Related U.S. Application Data
(60) Provisional application No. 60/171,889, filed on Dec. 23, 1999.

(51) Int. Cl. G02B 6/28; H01S 3/00

(52) U.S. Cl. 359/334; 359/333

(57) ABSTRACT

A lossless optical link in an optical transmission system comprises an optical fiber that is configured to produce Raman gain and provide for Raman distributed gain, via one or more pump sources, along the fiber so that, as an end result, the gain experienced by one or more propagating signals in the fiber link is made fairly uniform along the link or at least a portion of the optical link, such as not vary, for example, no more than five dB along the length of the optical fiber. The several embodiments disclosed provide for different optical pump/component architectures to achieve this end result.

### CROSS-REFERENCE TO RELATED APPLICATION

This application claims priority benefits of prior filed copending U.S. provisional application Serial No. 60/171,889, filed Dec. 23, 1999, which is incorporated herein by reference.

### TECHNICAL FIELD

The present invention generally pertains to optical transmission systems and pertains more particularly to providing an effectively lossless optical fiber link.

### BACKGROUND

Optical transmission losses in an optical fiber are inherent due to a number of factors including Rayleigh scattering and absorption. An effectively lossless optical transmission link can be achieved by offsetting such loss with optical gain.

One way in which transmission losses may be offset is by interposing an optical amplifier, such as an erbium-doped fiber amplifier (EDFA) between spans or links of optical fiber or in discrete locations along the length of an optical fiber. If the gain of each amplifier is matched to the loss of an adjacent fiber link, the overall end-to-end effect of interconnected links and amplifiers can be a transmission system that is substantially lossless.

Unfortunately, in practical implementations, the use of this solution is less than ideal because the length of each optical fiber length must be chosen to balance competing interests. On one hand, longer fiber links are desirable to reduce the costs needed to provide, install and maintain the amplifiers. On the other hand, shorter fiber links are desirable to reduce the level of optical loss incurred in each link so that less amplifier gain is needed to offset these losses. By reducing the gain requirements of each amplifier, the development or occurrence of ASE is reduced or substantially eliminated and the launch power for a given number of fiber spans is ultimately reduced along with a corresponding reduction in any accumulated ASE.

Another way in which transmission losses may be offset is by distributed Raman amplification. According to this technique, an optical fiber is provided with optical pumping energy at a wavelength that is shorter than the wavelength of the signal to be amplified. Raman scattering causes energy to be transferred from the pumping energy wavelength to the signal wavelength, thereby amplifying the signal and offsetting transmission losses. This technique is attractive because the gain can be distributed along the length of the optical fiber, referred to as distributed Raman amplification, rather than concentrated in the discrete locations as is the case for localized optical amplifiers in place along the optical fiber.

For Raman amplification as well as EDFA amplification, pumping energy is provided in the same direction as signal propagation is referred to as co-propagation pumping or more simply as “co-pumping”. Providing pumping energy in the direction opposite to signal propagation is referred to as counter-propagation pumping or more simply as “counter-pumping”. Co-pumping transfers noise on the optical pump beam to an optical signal more readily than counter-pumping because the relative walkoff velocity of the two beams is less for co-pumping than for counter-pumping. Also, even if the pump beam initially has no variation in its power level, it is possible for one signal channel to take energy away from the pump (via the gain mechanism) and thus affect the gain seen by the remaining signal channels. This pump-mediated crosstalk noise is more problematic in co-pumping than counter-pumping, again for reasons of relative walkoff velocity. Co-pumping also provides higher gain at the upstream end of the optical fiber link where more gain is not necessarily needed since the signal is already generally strong at that point so that counter-pumping can be more attractive because it provides gain at the downstream end of an optical fiber link where more gain is desirable. Unfortunately, for both co-pumping and counter-pumping, the distribution of gain provided by Raman amplification is not optimum because the gain diminishes with increasing distance from the pump source due to the intensity of the pumping energy diminishing as it propagates along the fiber.

### SUMMARY OF THE INVENTION

It is an object of the present invention to provide an effectively lossless optical fiber that provides for optical gain along an optical fiber link.

Another object of this invention is the provision for Raman distributed amplification in an optical fiber link.

A further object of this invention is the provision of Raman distributed gain at an internal portion of an optical fiber link.

A still further object of this invention is provision of a peak Raman gain spectrum at a point along an optical fiber link.

These objects are achieved by the present invention as described below.

According to this invention, an optical fiber link or transmission fiber in an optical transmission system comprises an optical fiber configured to produce Raman gain and provide for signal propagation in a signal wavelength range and to provide for Raman distributed gain along at least a portion of the fiber link. A Raman pump source is coupled to the link to provide Raman distributed gain at a point where it is higher in an internal portion of the fiber than compared to either said of such a internal portion of the fiber link. The distributed gain may include rare earth generated gain at the signal wavelengths as well as Raman generated gain. Also, one or more fiber Bragg gratings may be provided in the fiber link or in the coupling fiber or pigtail fiber between the Raman pump source and the fiber link to provide for gain distribution along the fiber link. In addition, a plurality of gain cavities can be provided in the internal portion of the fiber link which are spatially separated or overlapping. Such gain cavities can be Raman generated gain or rare earth generated gain or a combination of both. The Raman pump source may be stabilized as to its wavelength or its wavelength spectrum by employing a stabilizing fiber Bragg grating at the pump source output. In such a case, the pump source may be driven to coherence collapse operation.

Another feature of this invention is an optical fiber link comprising an optical fiber configured to produce Raman gain and to provide for Raman distributed gain for a plurality of optical signals propagating along the fiber link. At least one Raman pump source is provided having a predetermined optical power level as provided via a control circuit for the pump source. Also, the control circuit may dynamically vary the wavelength output of the pump source. A controller is employed to detect the number of optical signals propagating along the fiber and reduce or increase the pump source power as the number of optical signals propagating along the fiber is correspondingly reduced or increased. In the case of one pump source, the wavelength of its operation is at a first Raman order relative to the signal wavelength or bandwidth. In the case of two pumps, one pump operates at a first Raman order and the second pump operates at a second Raman order. The pumps may pump the optical link from opposite ends of the link or can be both counter-pumping the fiber link from the downstream end, i.e., counter-pumping relative to the direction of propagation of the optical signals.

Another feature of this invention is the provision of one or more Raman pump sources for a fiber link configured to provide Raman gain and to provide for Raman distributed gain along the link where a controller for the pump source(s) control(s) the bandwidth of the source(s) to be within the Raman gain bandwidth of the fiber.

A further feature of this invention is the provision of a fiber link in an optical fiber transmission system utilizing a fiber that has optical transmission characteristics substantially maintaining the power of a optical signal propagating through the fiber link which substantially experiences a lossless condition such that, for example, the signal power along the fiber varies no more than about five dB over about thirty kilometers or more. Reflectors, such as fiber Bragg gratings, in the fiber or in the fiber and the pump coupling fiber are utilized to distribute the first Raman order power or second Raman order power throughout the fiber link. In the case where the first and second Raman order pumps are combined to counter propagate the fiber link, the power level of the second Raman order pump, which is maintained at a level higher than the power level of the first Raman order pump, is controlled to vary the point of the peak Raman gain spectrum along the fiber link.

The various features of the present invention and its preferred embodiments may be better understood by referring to the following discussion and the accompanying drawings in which like reference numerals refer to like elements in the several figures. The contents of the following discussion and the drawings are set forth as examples only and should not be understood to represent limitations upon the scope of the present invention.

### BRIEF DESCRIPTION OF DRAWINGS

FIG. 1 is a schematic block diagram of an optical transmission system.

FIG. 2 is a hypothetical graphical illustration of signal power as a function of distance along a conventional optical transmission system of the type shown in FIG. 1.

FIG. 3 is a schematic block diagram of two optical fiber links in an optical transmission system employing Raman amplification to reduce transmission losses.

FIG. 4 is a hypothetical graphical illustration of signal power as a function of distance along an optical transmission system of the type in FIG. 3 employing Raman amplification to reduce transmission losses.

FIG. 5 is a schematic block diagram of two optical fiber links in an optical transmission system that employ counter -and co-pumped Raman amplification to provide more uniform optical gain along each link of the system.

FIG. 6 is a hypothetical graphical illustration of signal power as a function of distance along an optical transmission system of the type shown in FIG. 5 employing counter- and co-pumped Raman amplification.

FIG. 7 is a schematic block diagram of a single optical fiber link that uses counter- and co-pumped Raman amplification to reduce transmission losses so that a single link can provide reliable communication across greater lengths.

FIGS. 8-10 are schematic block diagrams of optical fiber links including one or more pump sources coupled to locations near the middle of the link.

FIG. 11 is a schematic block diagram of an optical link that receives wavelength-multiplexed pumping energy from two pump sources.

FIGS. 12-17 are schematic block diagrams of optical fiber links including one or more pump sources that deliver pump having wavelength, bandwidth and/or power that varies according to a controller.

FIG. 18 is a schematic block diagram of an optical fiber link that uses a reflective grating to stabilize a pump source.

FIG. 19 is a schematic block diagram of an optical fiber link that couples pump from a single pump source into multiple locations along the fiber link.

FIGS. 20A-20D are cross-section schematic diagrams of optical fiber.

FIG. 21 is a schematic block diagram of an optical fiber link in which stress is applied to polarization-sensitive fiber to change the overlap between orthogonally-polarized pumping energy and the signal at multiple locations along the fiber link.

FIG. 22 is a schematic block diagram of an optical fiber link that uses reflective gratings to control the distribution of pumping energy along the length of the fiber link.

FIG. 23 is a hypothetical graphical illustration of pump power as a function of distance along the optical fiber link that is illustrated in FIG. 22.

FIG. 24 is a schematic block diagram another embodiment similar to FIG. 22 of an optical fiber link that uses reflective gratings to control the distribution of pumping energy along the length of the fiber link where one of the gratings is close to the counter-propagating pump source, i.e., in its pigtail fiber.

FIG. 25 is a schematic block diagram of an optical fiber link that uses reflective gratings to control the distribution of pumping energy along the length of the fiber link similar to FIG. 24 except the one grating close to the counter-propagating pump source is at the output end of the fiber link.

FIG. 26 is a combination schematic block diagram and graphic illustration of an optical fiber link illustrating the distributed Raman amplification profile along a fiber link in the case of second Raman order co-propagating and first Raman order counter propagating pump sources.

FIG. 27 is a combination schematic block diagram and graphic illustration of an optical fiber link illustrating the distributed Raman amplification profile along a fiber link in the case of combined first and second Raman order counter-propagating pump sources.

FIG. 28 is a schematic block diagram of an optical fiber link that reduces transmission losses by providing Raman amplification in a fiber section that compensates for chromatic dispersion.

FIG. 29 is a hypothetical graphical illustration of signal power as a function of distance along an optical fiber link as a result of the gain provided by Raman amplification in a chromatic-dispersion compensating fiber segment.

### DETAILED DESCRIPTION OF THE INVENTION

A. Discrete Amplification

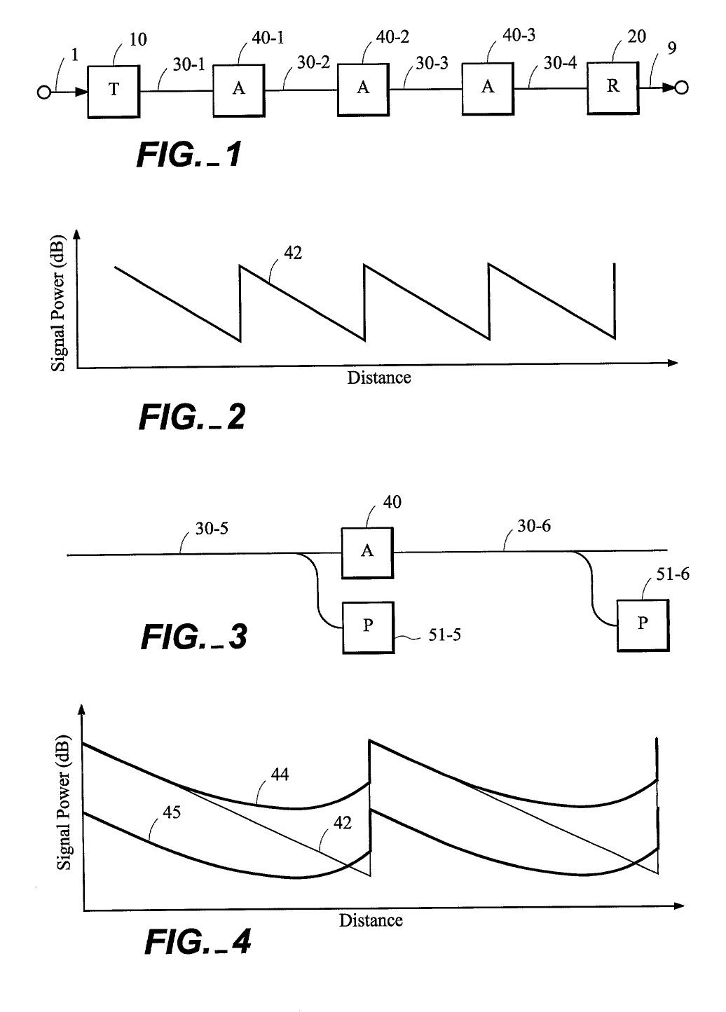

FIG. 1 provides a schematic block diagram of an optical transmission system in which transmitter 10 launches into the “upstream” end of optical fiber link 30-1 an optical signal that represents an electronic input signal received from path 1. The optical signal propagates along optical fiber link 30-1, sustaining losses in power or intensity due to several causes including Rayleigh scattering, optical couplers, splices, kinks and bends in the optical fiber, and various types of absorption, until it is received by optical amplifier 40-1. Optical amplifier 40-1 receives the optical signal at the “downstream” end of link 30-1 and launches into optical fiber link 30-2 an amplified replica of the received optical signal. The optical signal propagates along optical fiber links 30-2, 30-3 and 30-4 with amplification provided by optical amplifiers 40-2 and 40-3 until it reaches receiver 20. Receiver 20 generates along path 9 an electronic signal that represents the optical signal received from link 30-4. Each of the optical amplifiers may be a rare-earth doped fiber amplifier such as an erbium-doped fiber amplifier; however, no particular type or implementation of amplifier is critical.

FIG. 2 provides a hypothetical graphical illustration of optical signal power as a function of distance along the optical transmission system shown in FIG. 1. As shown by curve 42, optical signal power declines as the signal propagates along each optical fiber link and is boosted by each optical amplifier. If the gains of the optical amplifiers are carefully matched to the optical losses sustained in the fiber links, substantially “lossless” transmission can be provided between transmitter 10 and receiver 20. In this context, the term “lossless” refers only to signal power or intensity. It does not refer to the loss of signal quality that occurs because the optical signal-to-noise ratio (OSNR) of the optical signal steadily degrades from transmitter to receiver.

Assuming the OSNR of the optical signal received by receiver 20 is high enough to ensure reliable communication, the span from transmitter 10 to receiver 20 may be used as a complete transmission system or it may be used as one segment of a larger transmission system in which receiver 20 of one segment is used to electronically regenerate a digital signal for transmitter 10 of a subsequent segment.

B. Discrete Amplification with Distributed Raman Amplification

FIG. 3 provides a schematic block diagram of a portion of a transmission system like that shown in FIG. 1. In this portion, two optical fiber links 30-5 and 30-6 are coupled together by optical amplifier 40. By launching pumping energy into each link, Raman amplification may be provided to offset some of the optical fiber transmission losses. In the example shown in the figure, counter-pumping by pumping sources 51-5 and 51-6 provides for Raman amplification in links 30-5 and 30-6, respectively. As explained above, counter-pumping is generally preferred to copumping because counter-pumping is more resistant to noise in the pumping energy and to crosstalk between different amplified signals; however, co-pumping may be satisfactory in optical transmission systems that use a low-noise pumping source such as an InP semiconductor laser source. Furthermore, crosstalk may be reduced in copumped systems that convey a large number of optical signals due to an averaging effect of the signal patterns on the pump. For more information as to the types of pump sources that may be utilized in this invention as well as improvements to pump sources that improve system performance, see, for example, U.S. patent application, Ser. No. 09/430,394, filed Oct. 22, 1999 and entitled, MULTIPLE WAVELENGTH OPTICAL SOURCES; U.S. patent application, Ser. No. 09/489,800, filed Jan. 24, 2000 and entitled, CASCADED RAMAN RESONATOR WITH SAMPLED GRATING STRUCTURE; U.S. patent application, Ser. No. 60/224,108, filed Aug. 8, 2000 and entitled, SECOND ORDER RAMAN PUMPING ARCHITECTURES, and U.S. patent application Ser. No. (60/P1272) filed Dec. 21, 2000 and entitled, SECOND ORDER FIBER RAMAN AMPLIFIERS, which applications are all incorporated herein by their reference. In the embodiments in this application the pump sources may be a Raman resonator, cascaded Raman resonator, a cascaded Raman resonator powered by fiber laser, a semiconductor laser, a semiconductor optical amplifier (SOA) power by a fiber or semiconductor laser, or a semiconductor laser. In some cases, only one type of source can be employed in lieu of another, e.g., a semiconductor laser source can only be employed in cases of resonator distributed amplification, as will be evident from later discussion, because the use of a fiber laser source may result in feedback at different.

FIG. 4 provides a hypothetical graphical illustration of signal power as a function of distance along optical fiber links 30-5 and 30-6 as a result of the gain provided by optical amplifier 40 and Raman amplification distributed within the links. Curve 42 represents the signal power that results from transmission losses in optical fiber links 30-5, 30-6 and the optical gain of optical amplifier 40 without the benefit of Raman amplification. Curves 44 and 45 provide comparative illustrations of the signal power that can be achieved by adding Raman amplification.

In the example shown by curve 44, the power of the optical signal that is launched into link 30-5 is kept the same as that for the example shown by curve 42, and the gain of optical amplifier 40 is reduced according to the gain provided by Raman amplification so that the same optical power is launched into link 30-6. This implementation maintains a higher OSNR as compared to curve 42. The rate of accumulation of ASE noise along a cascade of amplifiers is reduced, thus maintaining a high OSNR after each span compared to the case represented by curve 42. In the example shown by curve 45, the power of the optical signal that is launched into link 30-5 is reduced as compared to the example for curve 42, and the gain of optical amplifier 40 is reduced so that this same optical power is launched into link 30-6. The level of launched power and the gain of optical amplifier 40 are chosen so that this implementation achieves the same OSNR as that for curve 42. This is the same OSNR at lower launch power because we have the same gain between the input and the output of the span but less ASE injected into the following span because of the reduced localized or discrete gain and the fact that the distributed Raman gain produces distributed ASE rather than lumping its ASE production at the span output.

The launched power can be set to any level but it is useful to point out that the power level can be set to balance a number of competing interests. On one hand, higher levels of launched power facilitate reliable transmission of higher data-rate signals and/or increased numbers of data channels, can be used to compensate for imperfections in electronic receiving and signal-regenerating circuitry, and permit the use of longer links between optical amplifiers. On the other hand, lower levels of launched power reduce the power requirements on the amplifiers and also reduce various non-linear impairments such as those caused by four-wave mixing, self-phase and cross-phase modulation, and Raman signal-to-signal interactions.

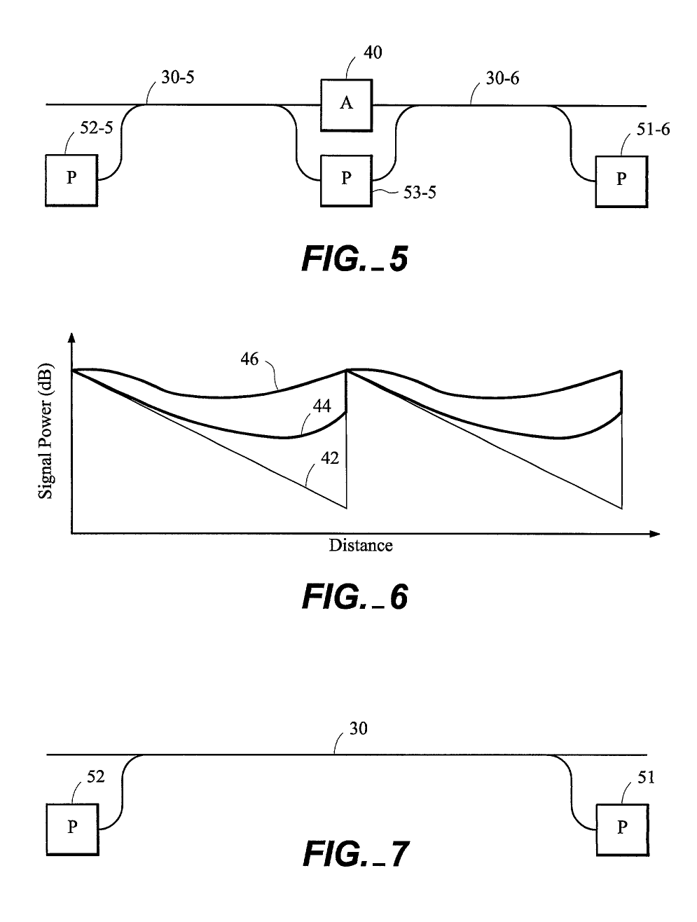

FIG. 5 provides a schematic block diagram of two optical fiber links and an optical amplifier similar to that shown in FIG. 4. In this example, pumping source 51-6 provides counter-pumping to optical fiber link 30-6, pumping source 52-5 provides co-pumping to optical fiber link 30-5, and pumping source 53-5 provides counter-pumping and co-pumping to links 30-5 and 30-6, respectively.

In one implementation, pumping sources 52-5, 53-5 and 51-6 provide pumping energy at the same or substantially the same wavelength, which differs from the wavelength of the signal to be amplified by one Stokes shift. For example, if the signal has a wavelength in a range from about 1530 nm to about 1560 nm, the wavelength of the pumping energy could be in a range from about 1430 nm to about 1460 nm.

Throughout this disclosure, references are principally made to wavelengths such as 1550 nm, 1450 nm and 1360 nm. These references should generally be understood to represent a range of wavelengths. For example, the nominal wavelength of 1550 nm is intended to represent a range of wavelengths such as, for example, from about 1530 to about 1610 nm.

In another implementation, counter-pumping by pumping sources 53-5 and 51-6 provides pumping energy at the same or substantially the same first wavelength, which differs from the signal wavelength by one Stokes shift, and co-pumping by pumping sources 52-5 and 53-5 provides pumping energy at the same or substantially the same second wavelength, which differs from the signal wavelength by two Stokes shifts. Stated differently, the second pumping wavelength differs from the first pumping wavelength by one Stokes shift. In this implementation, counter-pumping provides Raman amplification for the signal and co-pumping provides Raman amplification for the counter-pumped pumping energy. Raman amplification provided by co-pumping partially offsets the transmission losses sustained by the counter-pumping energy. The co-pumping energy amplifies the counter-pump energy thus providing substantial signal gain at both the output and the input end of the link. In this particular implementation, it can be seen that pumping source 53-5 provides pumping energy at two different wavelengths.

FIG. 6 provides a hypothetical graphical illustration of signal power as a function of distance along an optical transmission system in which curve 46 represents optical signal power obtained from Raman amplification provided by counter- and co-pumping. In this example, transmission losses of the optical fiber links are more closely offset along the entire length of each link and the gain of optical amplifier 40 may be reduced to zero or essentially zero. Note that in such a case the transmission system uses all Raman gain and the need for Er-doped amplifiers might be obviated. The improved match between fiber transmission losses and distributed Raman amplification gain may be exploited in a number of ways including the use of longer links or lowered signal launch power which avoids nonlinear impairments. FIG. 7 provides a schematic block diagram of this situation where a single optical fiber link 30 uses counter- and co-pumped Raman amplification to provide reliable communication across the same distance that is spanned by the two links shown in FIG. 3, for example, about 1360 nm co-propagating and about 1455 nm counter-propagating.

Throughout the remainder of this disclosure, more particular mention is made of examples using only counter-pumping sources; however, it should be understood that the principles and implementations taught by these examples also apply to copumping sources and that, in preferred embodiments, both counter- and co-pumping is used.

C. Pumping Schemes

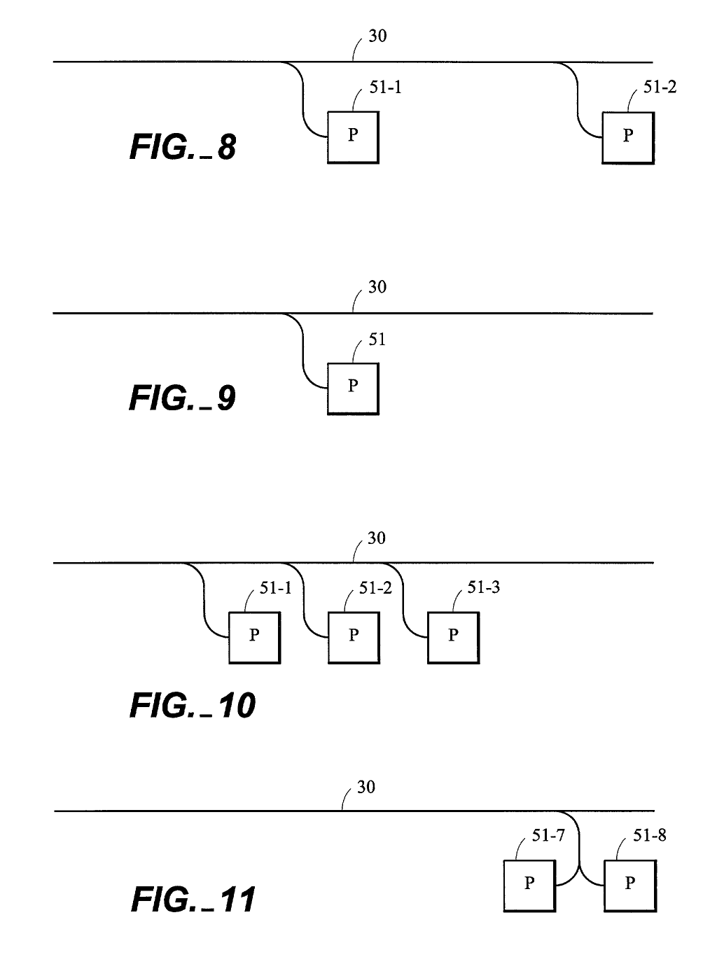

FIGS. 8-10 provide schematic block diagrams of several examples for providing pumping energy to an optical fiber link. In the example shown in FIG. 8, pumping source 51-2 provides pumping energy at or near the downstream end of optical fiber link 30 and pumping source 51-1 provides pumping energy at or near the middle of link 30. In the example shown in FIG. 9, pumping energy is provided only by pumping source 51 at or near the middle of link 30. Pump source 51 in FIG. 9 can be coupled to provide pump energy both upstream and downstream of link 30. In the example shown in FIG. 10, multiple pumping sources 51-1 through 51-3 provide pumping energy at locations that are distributed along a middle portion of link 30. Fewer counter-pumping sources may be needed, or counter-pumping sources may be separated from one another more widely if one or more co-pumping sources are also used.

These examples show several ways for providing counter-pumping energy at locations where Raman amplification of the signal is desired most. Preferably, little or no Raman amplification is provided at or near the upstream end of an optical fiber link in transmission systems that use optical amplifiers to boost signal power between links. As mentioned above, pumping energy may be provided at one or more wavelengths. The wavelengths may be exactly the same, or substantially the same in the sense that they differ from the signal wavelength by the same number of Stokes shifts, or they may differ significantly in the sense that they differ from the signal wavelength by a different number of Stokes shifts.

Each pumping source may be a wavelength-multiplexed and/or polarization-multiplexed combination of multiple sources as shown by the example illustrated in FIG. 11. In this example, the pumping energy generated by pumping sources 51-7 and 51-8 is multiplexed together and launched to counter-propagate into optical fiber link 30.

D. Controlled Pumping

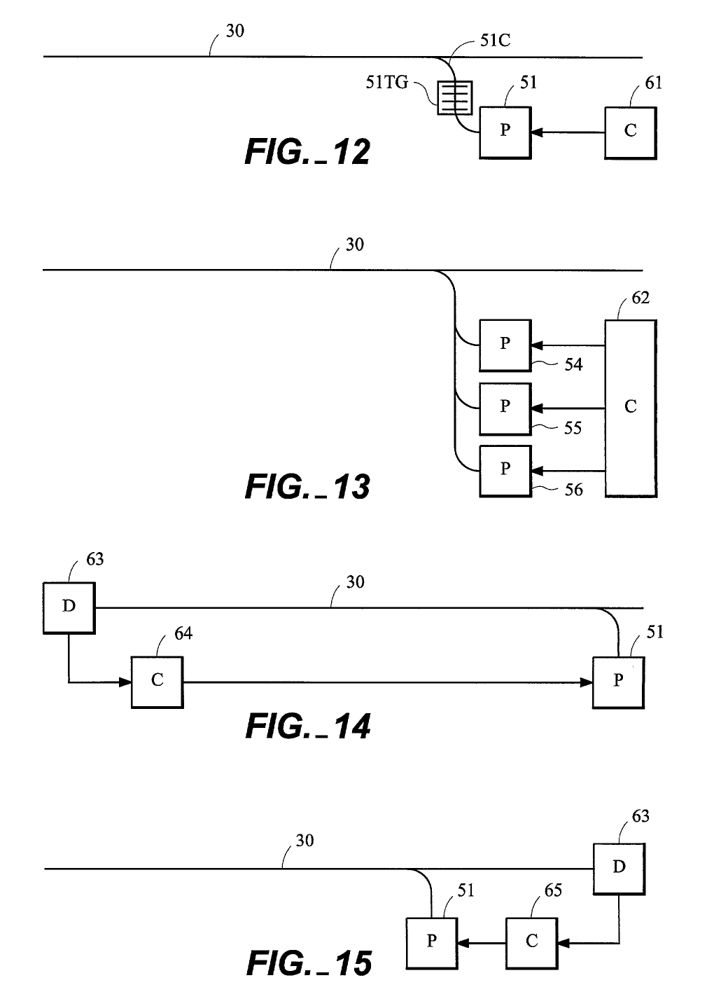

Pumping energy provided by some or all pumping sources may be controlled to improve the operating characteristics of optical fiber link 30. FIGS. 12-17 provide schematic block diagrams of several examples in which various characteristics of pumping energy are varied in response to a pump controller. FIG. 18 provides a schematic block diagram of an example in which output power of a pumping source is stabilized.

In the example shown in FIG. 12, controller 61 is used to vary wavelength, bandwidth and/or power of pumping energy by controlling the operation of a single pumping source 51. This control may be used to compensate for changes in operating conditions such as variations in the number or intensity of optical signals or changes in operating characteristics of optical fiber link 30, such as changing signal traffic on the link, or other components like optical amplifier 40 that are caused by change in signal power due to channel loading, aging of the fiber link or variations in the operating environment like temperature. Also a tunable Bragg grating 51TG can be employed in coupling fiber 51C to control the bandwidth of the wavelength spectrum output of pumps source 51 so as, for example, to be in the Raman gain bandwidth of fiber link 30. The bandwidth of grating 51TG is changed through the tuning function, as is now known in the art such as, for example, by strain inducement, heat application of heat, piezo-electric induced vibrations and other such techniques to vary the grating bandwidth and its peak wavelength. Some examples thereof are set forth in U.S. Pat. Nos. 6,141,470 and 6,154,590, which are incorporated herein by their reference.

Alternatively, variations in pumping energy may be obtained by controlling the operation of multiple pumping sources as shown in FIG. 13. For example, pumping sources 54-56 may each provide pumping energy at a different wavelength, bandwidth or power level and, in response to controller 62, these pumping sources may be selected to operate individually or in any combination. For example, the combined bandwidth output of sources 54, 55 and 56 can be adjusted through power cutoff or power adjustment of the sources so that their combined wavelength output is within the Raman gain bandwidth of the fiber link 30.

In each of the examples discussed below, reference is made to controlling single pumping sources; however, it should be understood that each of these single pumping sources may be replaced by a combination of multiple sources operating under a common controller.

In the example shown in FIG. 14, optical fiber link 30 is used to transmit one or more distinct optical signals, perhaps differing from one another in wavelength. Detector 63 at the upstream end of optical fiber link 30 is used to detect the number of distinct signals that are being transmitted at any give time and, in response, controller 65 causes counter-pumping source 51 to provide higher levels of pumping energy when larger numbers of signals are being transmitted and lower levels of pumping energy when smaller numbers of signals are being transmitted. Also, controller 65 can also change the wavelength spectrum of pump source 51 in response to the wavelength spectrum of signal channels currently loaded on the link.

Alternatively or in addition to the control of pumping energy level, controller 64 may cause counter-pumping source 51 to vary pumping energy wavelength in response to various characteristics such as the spectral content of the signals being transmitted. This may be accomplished in a variety of ways. One way varies the output level of multiple pumping sources that provide different wavelengths of pumping energy. Another way varies the operating temperature of a semiconductor diode laser pumping source. Yet another way varies the strain of reflective gratings used to tune the wavelength of a pumping source. Essentially any technique for varying the wavelength of a laser source may be used including known techniques for providing wavelength-tunable lasers.

Other arrangements are provided in the examples shown in FIGS. 15 to 17. The arrangement shown in FIG. 15 differs in that detector 63 is located at the downstream end of optical fiber link 30 and detector 63 is used to control, via controller 65, counter-pumping source 51 in the middle portion of optical fiber link 30.

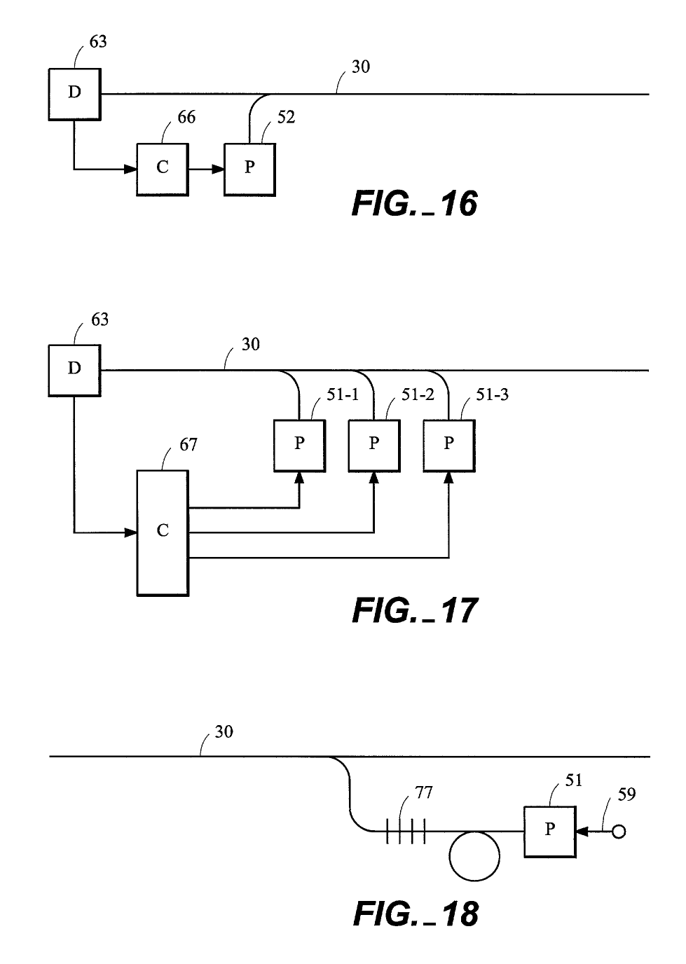

The arrangement shown in FIG. 16 differs from the example shown in FIG. 14 in that detector 63 is used to control the operation of co-pumping source 52. This implementation provides a faster response as compared to the other implementations discussed above because there are no propagation delays for either the optical signal, as in the case of the embodiment in FIG. 15, or in the case of the control signal in FIGS. 14 and 17. Nevertheless, despite the propagation delays, these other implementations can provide a faster response than can be achieved using rare-earth doped fiber amplifiers because gain changes in Raman amplification are essentially instantaneous. In FIG. 17, detector 63 is located in the upstream end of fiber link 30 and is used to control, via controller 67, counter-pumping sources 51-1 to 51-3 spatially distributed along the middle portion of optical fiber link 30. Here, the bandwidth of these sources can be controlled so that their combined wavelength output are within the Raman gain bandwidth of fiber link 30.

The example shown in FIG. 18 represents a different type of pumping source control. In this example, the output of pumping source 51 is stabilized by forcing the source to operate in coherence collapse. This is disclosed in U.S. Pat. Nos. 5,485,481 and 5,715,263, which are incorporated herein by reference. This may be achieved by placing reflective grating 77 in the optical path of the pumping energy at an optical distance from the source that exceeds its so-called coherence length. In addition, operation in coherence collapse can be facilitated by driving pumping source 51 with time-varying drive current 59. Additional details on achieving coherence collapse may be obtained from U.S. patent application Ser. Nos. 08/621,555, filed Mar. 25, 1996, and 09/197,062, filed Nov. 20, 1998, both of which are incorporated herein by reference.

E. Pump Coupling

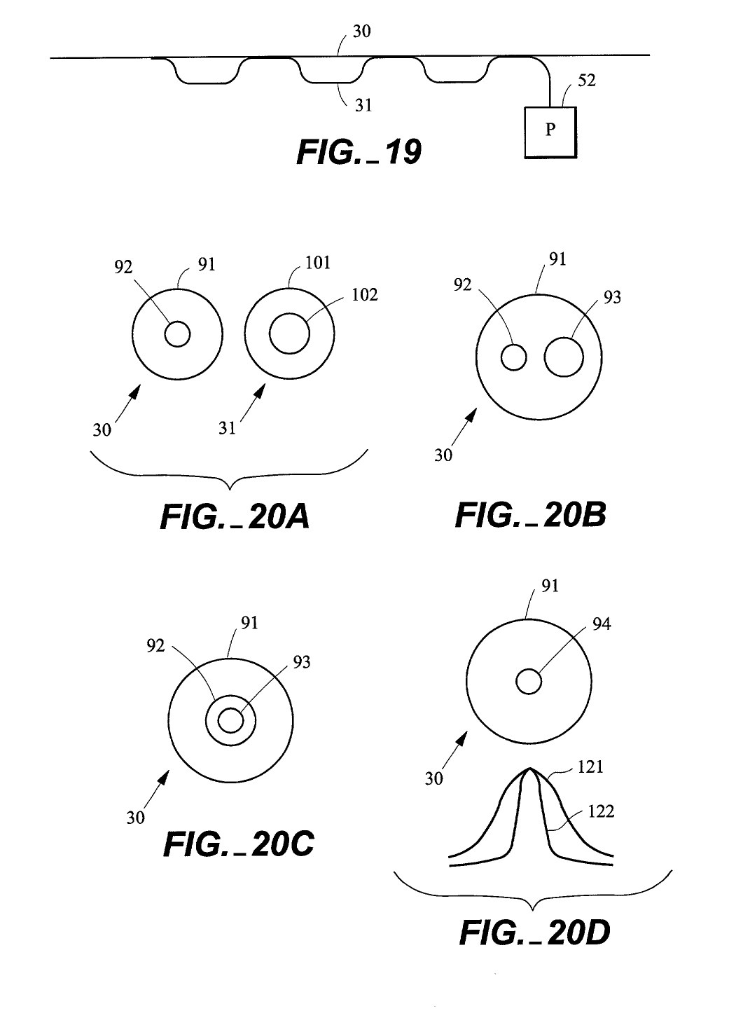

In the examples discussed above, little mention is made of the way in which pumping energy may be coupled into the optical fiber carrying the signal to be amplified. The drawings that illustrate those examples imply a conventional type of fused coupling. FIGS. 19 to 20 illustrate several additional ways to couple pumping energy into optical fiber link 30.

In the example shown in FIG. 19, pumping source 52 emits pumping energy into optical fiber 31, which is coupled to optical fiber link 30 at one or more locations. This arrangement is also illustrated in FIG. 20A. As shown in the cross sectional view of optical fiber link 30, core region 92 is surrounded by outer region 91. The choice of materials, dopant if any, and geometry for these two regions preferably is selected to optimize the transmission of the optical signals to be amplified. For example, the mode field diameter of core region 92 may be reduced to reduce signal dispersion. Similarly, optical fiber 31 includes core region 102 surrounded by outer region 101; however, the choice of materials, dopant if any, and geometry for these two regions preferably is chosen to optimize the transmission of the pumping energy. For example, the mode field diameter of core region 102 may be increased to reduce pumping energy transmission losses while decreasing the numerical aperture of fiber 31. Core regions 92 and 102 may be fused occasionally to couple the two fibers at distributed locations.

Alternatively, signal and pumping energy may be combined using a single optical fiber. Referring to FIG. 20B, a first core region 92 for the signal and a second core region 93 for the pumping energy are essentially parallel to one another and are both surrounded by outer region 91. Referring to FIG. 20C, first core region 92 for the signal and second core region 93 are coaxial. Referring to FIG. 20D, a single core region 94 that is surrounded by outer region 91 supports two optical modes, a first mode 121 for the signal and a second mode 122 for the pumping energy.

In each of these implementation, the materials, dopants if any, and geometry of the various regions may be established to transmit and couple the pumping energy and signal in whatever way is desired. Preferably, the overlap of the pumping energy with the optical signal path is increased where more Raman amplification is desired.

F. Raman Gain Distribution

In addition to the considerations discussed above, the distribution of Raman amplification or gain can be controlled to achieve a desired distribution of gain. If all of the gain that is realized by Raman amplification is confined to an interval or limited distance (for example, 5 km) at or near the downstream end of an optical fiber link, very little benefit in OSNR can be realized over what can be achieved using only conventional optical amplifiers between links. In an ideal implementation, the gain realized by Raman amplification is distributed uniformly along the entire length of the optical fiber. Unfortunately, this is difficult to achieve in practical implementations. Perfectly uniform amplification or gain, either Raman gain or from rare-earth provided gain, in the transmission fiber suffers from the accumulation of noise in the signal from multiple Rayleigh reflection events. Thus, the optimum gain distribution is necessarily not uniform.

Several ways for controlling the distribution of Raman amplification to achieve a more uniform gain distribution than can be achieved from single-ended, single wavelength is discussed below.

1. Polarization

The gain that is achieved by Raman amplification depends on both the intensity of the pumping energy and the degree to which the polarization orientations of the pumping energy and the signal overlap. Raman amplification gain for orthogonally-polarized signal and pumping energy is very small. In transmission systems that use polarization insensitive optical fiber, the birefringent properties of the fiber cause the polarization orientations of the signal and the pumping energy to fluctuate. These fluctuations and the resulting Raman amplification gain are effectively averaged over the length of the optical fiber.

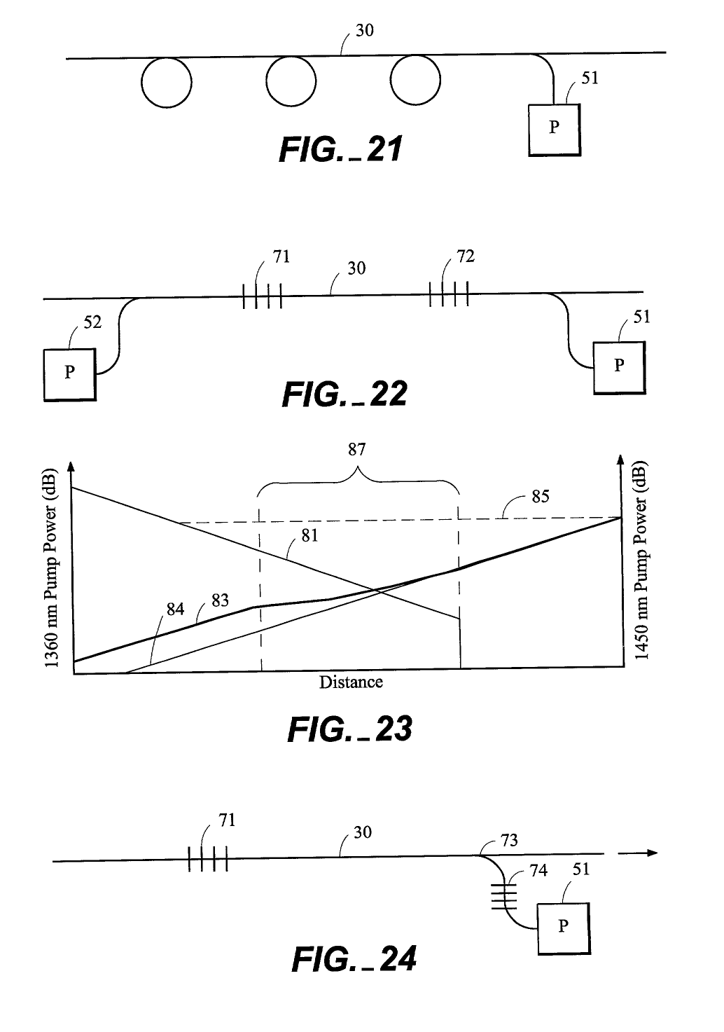

In the example shown in FIG. 21, optical fiber link 30 is a polarization-sensitive or polarization maintaining (PM) fiber and pumping source 51 provides pumping energy that has a polarization orientation that is substantially orthogonal to the polarization of the signal to be amplified. By imposing stress upon optical fiber link 30 at one or more locations along its length, the PM properties of the fiber can be perturbed, which in turn perturbs the relative polarization orientation of the signal and the pumping energy, thereby allowing some of the pumping energy to align its polarization with the signal. The remaining pumping energy propagates along the optical fiber until it is either attenuated by transmission losses or its polarization orientation overlaps with the polarization orientation of the signal at another point of perturbation.

Alternatively, the orthogonal polarization orientation of the pumping energy may be preserved, allowing the pumping energy to propagate along the optical fiber until it reaches a location where Raman amplification is desired. The PM properties of the optical fiber can be disrupted at that location to allow the polarization orientation of the pumping energy to completely overlap with the polarization orientation of the signal.

2. Reflectors

The distribution of pumping energy within an optical fiber link can be controlled by reflectors that are designed to pass signal wavelengths but reflect certain pumping wavelengths. Fiber Bragg gratings (FBG) are one practical way to implement such reflectors; however, in principle, no particular type of reflector is critical to the present invention.

FIG. 22 provides a schematic block diagram of an optical fiber link that uses reflectors 71 and 72 to control the distribution of counter- and co-pumping energy provided by pumping sources 51 and 52, respectively. The distribution is controlled to increase the amount of Raman gain in the middle portions of the optical fiber link and to avoid or limit increases in Raman gain at or near the upstream end of the fiber link where signal power levels approach the limits of linear or substantially linear operating characteristics of the fiber. In one example, the signal wavelength is 1550 nm, the co-pumping wavelength of pumping source 52 is 1360 nm and the counter-pumping wavelength of pumping source 51 is 1450 nm. Reflector 71 has a reflectivity level of essentially zero at 1360 nm and a reflectivity level of essentially 100% at 1450 nm. Reflector 72 has a reflectivity level of essentially 100% at 1360 nm and a reflectivity level of essentially zero at 1450 nm. According to this example, counter-pumping energy from source 51 is substantially confined to the portion of optical fiber link 30 between reflector 71 and pumping source 51. Conversely, co-pumping energy from source 52 is substantially confined to the portion of optical fiber link 30 between pumping source 52 and reflector 72. The 1360 nm co-pumping energy is distributed to increase Raman amplification of the 1450 nm counter-pumping energy in a middle portion of optical fiber link 30. As a result, the intensity of the 1450 nm counter-pumping energy is increased and made more spatially uniform in this middle portion of the link which, in turn, increases Raman amplification of the signal at 1550 nm along this portion of the link. Thus, it can be seen that with the placement of the reflector pair 71, 72, any portion of the link as well as the link itself may be provided with distributed gain continuous along the length of optical fiber link 30.

FIG. 23 provides a hypothetical graphical illustration of pump power as a function of distance along the optical fiber link as a result of the gain provided by Raman amplification. Curve 81 represents the power level of 1360 nm pumping energy. Curve 83 represents the power level of 1450 nm pumping energy without the benefit of the Raman gain provided by the 1360 nm pumping energy, and curve 84 represents the power level of 1450 nm pumping energy with the benefit of the Raman gain provided within interval 87 of the optical fiber link. The net result of pump power along the fiber link is represented by dotted line 85 which, as can be seen in FIG. 23, is fairly spatially uniform and continuous along its length.

One or more reflectors may be used to achieve a wide variety of distributions of pumping energy along the fiber link.

FIG. 24 discloses another embodiment for distributed Raman amplification in fiber link 30 using a reflector pair or pairs to spatially distribute first Raman order pump power. Here, a semiconductor laser source, such as, for example, an InP/InGaAs laser, is employed since it will not provide any feedback at a different stokes shift as in the case of a fiber laser source. As an example, pump 51 operates at 1363 nm, i.e., at a second Raman order relative to a signal wavelength around 1550 nm, and has, in its coupling fiber or pigtail fiber 79, a fiber Bragg grating with a reflective bandwidth with a peak around 1455 nm, or the first Raman order relative to signal wavelength around 1550 nm. Fiber link 30 includes, well upstream, a fiber Bragg grating 71 that is 100% reflective of the first Raman order wavelength at 1455 nm and is transparent to the signal wavelength at 1550 nm, propagating from left to right along fiber link 30. WDM coupler 73 is, for example, a fused biconical coupler fabricated or drawn to permit the coupling between link 30 and fiber 79 of the first Raman order wavelength but not the signal wavelength, which remains on fiber link 30. In operation, pump source 51 provides second Raman order pump power counter-propagating in fiber link 30 that is stokes shifted to the first Raman order or 1455 nm which provides distributed gain to the 1550 nm signal as first Raman order propagates along link 30 toward fiber Bragg grating 71. Any residual first Raman order pump light is reflected by reflector 71 downstream in the link where it may be reflected again by reflector 74 back into fiber link 30. Thus, reflectors 71 and 74 primarily confine substantially all of the 1455 nm first Raman order energy within an optical cavity formed between these two reflectors.

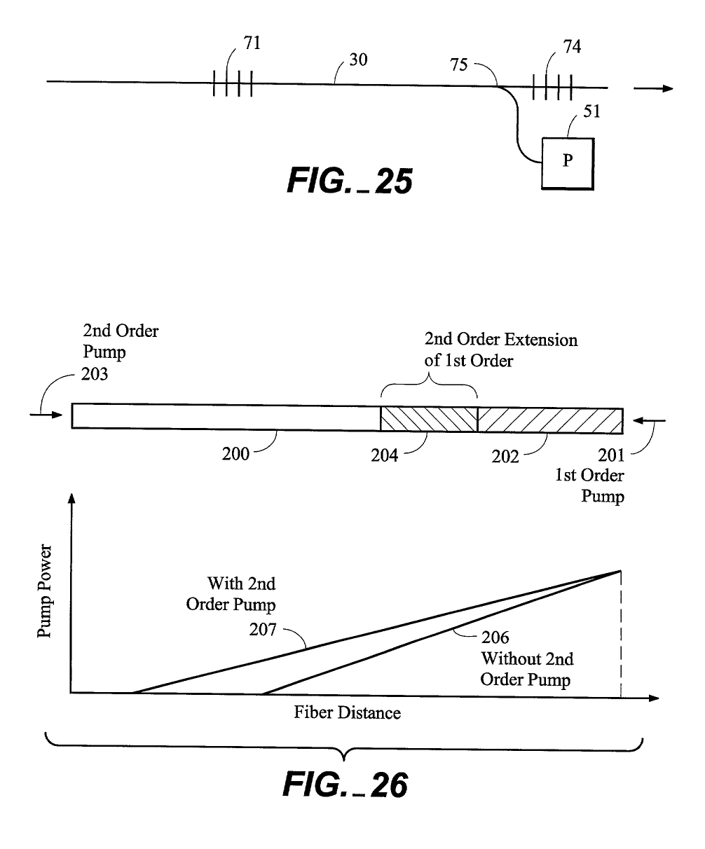

Another version of the embodiment shown in FIG. 24 is illustrated in FIG. 25. Here, fiber Bragg grating reflector 74 is positioned in fiber link 30 beyond and downstream of WDM coupler 75 rather being placed in pigtail fiber 79. Further, WDM coupler 75 is fabricated so that first Raman order wavelength at 1455 nm and the propagating signal to be amplified at 1550 nm remain in link 30 and the second Raman order wavelength at 1363 nm from pump source 51 is coupled through WDM coupler 75 to counter-propagate in fiber link 30. As is the case of the version in FIG. 24, an optical cavity is established in an optical cavity formed between reflectors 71 and 74 so that the first Raman order, 1455 nm pump energy is spatially confined between reflectors 71 and 74 in link 30 to provide gain to the propagating signal at 1550 nm.

3. Extension and Peak Spectrum Distribution of Raman Gain Along the Fiber Link

Reference is now made to FIG. 26 illustrating co-propagating pump energy at a second Raman order, for example, at 1363 nm, and counter-propagating pump energy at a first Raman order, for example, at 1455 nm, in fiber link 200. Thus, Raman gain is achieved in fiber link 200 for optical signals, such as around 1550 nm via first Raman order pump light. As illustrated in FIG. 26, the second Raman order extends the penetration of first Raman order pump energy from the counter pump source 51, which extension is diagrammatically illustrated at 204, further upstream in fiber link 200 toward the second Raman order pump energy source 203, as compared to the case in the absence of such second Raman order pump energy diagrammatically illustrated at 202. The effect of this extension of Raman distributed gain at 204 is graphically illustrated in FIG. 26 wherein the pump power for providing gain to the signal is extended upstream in fiber link 200, as indicated by line 207, as compared to the case where no second Raman order pump energy is present, as indicated by line 206, which, of course, does not extend as far upstream in link 200.

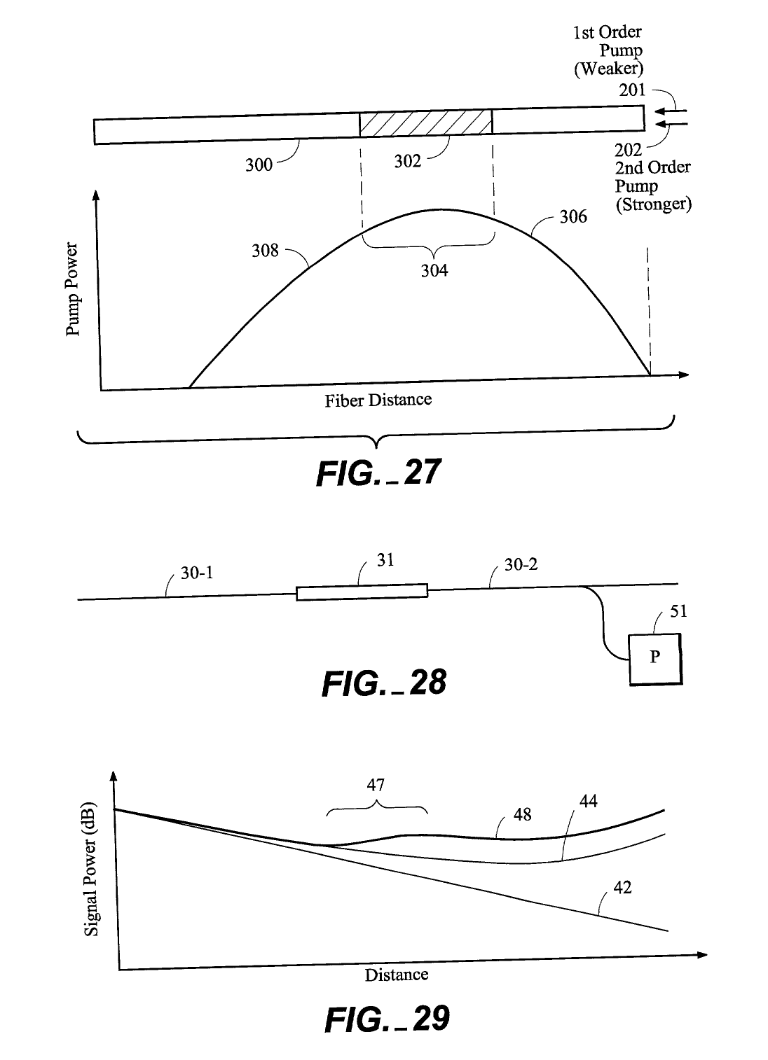

Reference is now made to FIG. 27 illustrating the employment of combined first Raman order and second Raman order pump energy at 301 and 303 coupled at the downstream end of fiber link 300 for counter-propagating in the link. As an example, the first Raman order pump wavelength may be 1455 nm and the second Raman order wavelength may be 1363 nm. As explained previously, the second Raman order provides gain to the first Raman order which provides signal amplification. With greater gain provided to the first Raman order, its capacity for distributed amplification or gain along fiber link 300 is extended further upstream in the link and its peak Raman gain spectrum 304 can be toward the internal portion of fiber link 300.

These pump sources may be coupled to fiber link 300 in the manner as previously illustrated and discussed in connection with FIG. 11. In the case here, however, the pump energy of the second Raman pump source is made stronger or higher than that of the first Raman order pump source so that the peak spectrum of Raman distributed amplification is extended further upstream in fiber link 300 as illustrated at 302 in fiber link 300 in FIG. 27 as well as the peak Raman gain spectrum 304 as indicated in the Raman distributed amplification profile 306 in the graphic representation of FIG. 27. As a result, also, there is an extended upstream distribution of Raman pump power as indicated by the descending portion 308 of profile 306. It will be realized that by adjusting the relative power levels of the first and second Raman order pump energies, the point of the peak Raman gain spectrum 304 can be changed along fiber link 300, i.e., the higher the second order power, the greater the distance upstream of the point of the peak Raman gain spectrum 304 into the fiber link internal portion, and the lower the second order power, the less the distance upstream of the point of the peak Raman gain spectrum 304 into the fiber link internal portion.

4. Chromatic Dispersion Compensation

All types of optical fiber manifest a characteristic known as chromatic dispersion, which is caused by different wavelengths traveling at different velocities in the fibers. Chromatic dispersion is undesirable because it causes temporal packets of light, often used to represent binary bits of information, to spread and overlap with other packets of light. Techniques are known to produce optical fibers that have low chromatic dispersion. Unfortunately, these fibers manifest other deficiencies including degraded signal quality caused by four-wave mixing, self- and cross-phase modulation impairments. Therefore, to overcome both problems simultaneously, it is necessary to form optical fiber links that simultaneously have high amounts of “local” chromatic dispersion and low amounts of “global” chromatic dispersion. This can be achieved by joining segments of fiber having two different chromatic-dispersion characteristics. The chromatic-dispersion characteristics of one fiber type is used to offset or cancel the dispersion sustained in the other fiber type. The lengths of each type of fiber are chosen to yield an overall effect of essentially no chromatic dispersion.

The type of fiber that is inserted into an optical fiber link to provide an overall effect of little or no chromatic dispersion is often referred to as a dispersion-compensation (DC) fiber. DC fibers can be placed in many locations. For example, DC fiber can be placed at any point of an optical fiber link including the middle, the end, or between stages of a dual-stage inline optical amplifier. One or more segments of DC fiber may be used.

Generally, DC fiber has higher concentrations of germanium and a smaller mode-field diameter than does typical transmission fiber. Both of these features provide for a higher Raman amplification gain. These characteristics can be used to improve gain uniformity in an optical fiber link. An example of an optical fiber link that uses a segment of DC fiber as a Raman amplifier is shown in FIG. 28. In this example, segment 31 is a DC fiber that is placed between segments 30-1 and 30-2 of optical fiber.

FIG. 29 provides a hypothetical graphical illustration of signal power as a function of distance along the optical fiber link as a result of the gain provided by Raman amplification in DC fiber segment 31. Curve 42 represents the signal power that results from transmission losses of the optical fiber link without benefit of Raman amplification. Curve 44 represents the signal power achieved using Raman amplification that results from pumping energy provided at the downstream end of the link without any additional gain provided by the DC fiber segment. Curve 48 represents the signal power achieved using the additional Raman amplification provided within interval 47 of DC fiber segment 31. A more uniform signal power can be achieved by using multiple segments of DC fiber in a similar manner.

5. Non-Uniform Optical Fiber Characteristics

One fundamental factor that affects the gain achieved by Raman amplification is the intensity of the pumping energy. If this pumping energy is coupled into an optical fiber link at one of its ends, then the Raman gain distribution is largely determined by the pump energy transmission characteristics of the optical fiber link.

This distribution can be modified by altering one or more characteristics of the optical fiber link along its length. Several examples of these characteristics that are discussed above include the germanium concentration, the mode-field diameter of the pumping energy, and the spatial separation of signal and pumping energy. Another example is the glass or “host” composition of the optical fiber.

Yet another way to achieve a more uniform gain distribution is to augment Raman amplification with other types of amplification. One type of amplification can be provided by a rare-earth dopant such as erbium and a suitable pump source. Preferably, the concentration of the rare-earth dopant varies along the length of the optical fiber link to provide a varying amount of gain that complements the varying gain provided by Raman amplification.

Although the invention has been described in conjunction with several preferred embodiments, the features in any one embodiment may be used in another embodiment. Also, it will be apparent to those skilled in the art that other alternatives, variations and modifications will be apparent in light of the foregoing description as being within the spirit and scope of the invention. Thus, the invention described herein is intended to embrace all such alternatives, variations and modifications that are within the spirit and scope of the following claims.

What is claimed is:

1. An optical fiber link comprising:
an optical fiber configured to producer Raman gain and to provide for propagation of one or more optical signals propagating therealong;
a pump source coupled to the link for providing pump light providing optical Raman distributed gain along at least a portion of the fiber link;
said distributed gain higher along an internal portion of the fiber than either side of said internal portion.

2. The optical fiber link of claim 1 wherein the gain distribution is greater in the internal portion of the fiber link as compared to end regions of the fiber link.

3. The optical fiber link of claim 1 wherein pump light intensity is highest in the internal portion of the fiber transmission link as compared to end regions of the fiber link.

4. The optical fiber link of claim 1 further comprising:
a two-core fiber comprising said fiber link, one of said cores for propagation of said signals and the other of said cores for propagation of said pump light;
a plurality of distributed couplers along the internal portion between said cores for distributing pump light into the propagating signal core.

5. The optical fiber link of claim 4 wherein said fiber cores are juxtaposed in the fiber link.

6. The optical fiber link of claim 4 wherein said fiber cores are concentric in the fiber link.

7. The optical fiber link of claim 1 further comprising a rare earth dopant in a core of the fiber link along at least a portion of said fiber link internal portion.

8. The optical fiber link of claim 7 wherein said dopant is erbium.

9. The optical fiber link of claim 7 wherein said distributed gain is brought about by rare earth generated gain and Raman generated gain.

10. The optical fiber link of claim 1 further comprising a plurality of optical pumps periodically coupled to the fiber link along at least a portion of said internal portion.

11. The optical fiber link of claim 1 further comprising at least one fiber grating in the fiber link internal portion to provide for gain distribution therein.

12. The optical fiber link of claim 1 further comprising at least one gain cavity provided in the internal portion wherein gain is generated between end reflectors establishing the optical cavity.

13. The optical fiber link of claim 12 further comprising a plurality of gain cavities in the fiber link internal portion.

14. The optical fiber link of claim 13 wherein said gain cavities are spatially separated.

15. The optical fiber link of claim 13 wherein said gain cavities are overlapping.

16. The optical fiber link of any one of claims 13 through 15 wherein the gain generated is Raman generated gain.

17. The optical fiber link of any one of claims 1 through 15 wherein the gain generated is rare earth ion generated gain.

18. The optical fiber link of claim 1 further comprising a reflector for said pump light within the fiber to cause the pump gain provided by said pump source to be the greatest in said internal portion of the fiber link.

19. The optical fiber link of claim 18 wherein said reflector is a grating.

20. The optical fiber link of claim 1 further comprising a pump source including cascaded Raman resonator for shifting the pump wavelength to a generated wavelength providing gain to a signal or signals.

21. The optical fiber link of claim 20 wherein said cascaded Raman resonator is provided along said internal portion of said fiber.

22. The optical fiber link of claim 1 wherein there are a plurality of pump sources.

23. The optical fiber link of claim 22 wherein said pump sources are wavelength stabilized.

24. The optical fiber link of claim 23 wherein said pump stabilization is brought about by a fiber grating controlling the wavelength of each pump source.

25. The optical fiber link of claim 24 wherein each of said pump sources are driven into coherence collapse operation.

26. The optical fiber link of claim 24 wherein outputs of at least some of said pump sources are wavelength combined.

27. The optical fiber link of claim 1 wherein said pump source is wavelength stabilized.

28. The optical fiber link of claim 27 wherein said pump stabilization is brought about by a fiber grating controlling the wavelength of the pump source.

29. The optical fiber link of claim 27 wherein said pump source is driven into coherence collapse operation.

30. An optical fiber link comprising:
an optical fiber configured to produce Raman gain and to provide for propagation of a plurality of optical signals;
at least one pump source coupled to Raman pump light into the fiber having a predetermined power level;
a control circuit for operating the pump source;
a controller to detect the number of optical signals propagating along the fiber; and
said controller to reduce or increase the power level of the pump source as the total number of optical signals propagating along the fiber is correspondingly reduced or increased.

31. The optical fiber link of claim 30 wherein each optical signal is operating at a different wavelength.

32. The optical fiber link of claim 30 wherein a first pump source is at a wavelength of a first Raman order.

33. The optical fiber link of claim 30 wherein there are at least two pump sources, the first pump source is operating at a wavelength of a first Raman order and the second pump source is operating at a wavelength of a second Raman order.

34. The optical fiber link of claim 33 wherein said first Raman order pump source is counter propagating its light along the fiber and said second Raman order pump source is co-propagating its light along the fiber so that the Raman gain achieved in the fiber for said optical signals via said first Raman order pump light is extended a greater distance in the fiber toward said second Raman order pump source.

35. The optical fiber link of claim 33 wherein said first Raman order pump source is counter propagating its light along the fiber and said second Raman order pump source is counter-propagating its light along the fiber so that the Raman gain achieved in the fiber for said optical signals via said first Raman order pump light is extended a greater distance into the fiber because of energy transfer from the second Raman order pump to the first Raman order pump.

36. The optical fiber link of claim 30 wherein said controller provides for additional gain in the fiber when one or more of said optical signals are added to propagate in the fiber.

37. The optical fiber link of claim 30 wherein said pump source counter propagates in the fiber relative to said optical signals.

38. The optical fiber link of claim 30 wherein there are a plurality of pump sources.

39. The optical fiber link of claim 30 wherein said pump source or sources are wavelength stabilized.

40. The optical fiber link of claim 39 wherein pump stabilization is brought about by a fiber grating.

41. An optical fiber link comprising:
an optical fiber for propagation of a plurality optical signals propagating therealong;
said fiber having a predetermined Raman gain spectrum;
at least one pump source coupled to pump light into the fiber having a predetermined power level;
a control circuit for operating the pump source;
said circuit including means to dynamically vary the wavelength output of the pump source.

42. An optical fiber link comprising:
a plurality of signal sources;
a plurality of pump sources;
a subset of said signal sources activate at periods of time and inactivate at other periods of time; and
a subset of said pump sources reduced in power during said periods of time when said subset of signal sources is inactive.

43. An optical fiber link comprising a plurality of signal sources, a plurality of pumps sources capable of exciting Raman gain in the optical fiber link, wherein at least one pump source is adjusted to selectively increase or decrease pump power.

44. The optical fiber link of claim 43 wherein at least one pump source is capable of being controlled to substantially provide no Raman gain at a particular wavelength or wavelength bandwidth.

45. A optical fiber link comprising:
a transmission fiber configured to produce Raman gain and provide Raman distributed amplification along the fiber;
at least one signal for propagating along the transmission fiber;
at least one pump source for providing Raman gain in the fiber link; and
a reflector for said pump light within the fiber to cause the pump gain provided by said pump source to be discontinuous along the length of the fiber link.

46. The optical fiber link of claim 45 wherein said reflector is a fiber Bragg grating.

47. The optical fiber link of claim 45 further comprising a pump source that includes a Raman resonator.

48. A optical fiber link comprising:
a transmission fiber configured to produce Raman gain and provide Raman distributed amplification along the fiber;
at least one signal for propagating along the transmission fiber;
a first pump source for providing a first pump signal having stokes shifted gain in the fiber link to the signal source;
and a controller connected to said pump source for controlling the bandwidth of said sources to be within the Raman gain bandwidth of the fiber.

49. The optical fiber link of claim 48 further comprising a second pump source for providing a second pump signal having stokes shifted gain in the fiber link for the first pump signal.

50. The optical fiber link of claim 49 wherein both of said pump sources have their bandwidth controlled by said controller.

51. The optical fiber link of claim 49 wherein both of said pump sources have their bandwidth controlled by separate controllers.

52. The optical fiber link of claim 49 wherein each of said pump sources are driven into coherence collapse operation.

53. The optical fiber link of claim 49 wherein outputs of at least some of said pump sources are wavelength combined.

54. The optical fiber link of claim 48 wherein said pump source is wavelength stabilized.

55. The optical fiber link of claim 54 wherein said pump stabilization is brought about by a fiber grating controlling the wavelength of each pump source.

56. A lossless fiber link in an optical transmission system, the link comprising an optical fiber with optical transmission characteristics that produce Raman gain in the fiber such that power of an optical signal or signals at a signal wavelength or bandwidth propagating through the optical fiber from the first end to the second end varies by no more than about five dB along a length of the optical fiber of about thirty kilometers or more due to Raman distributed gain provided by a pump source coupled to the fiber.

57. A link according to claim 56 comprising a plurality of pump sources coupled to the optical fiber to obtain the optical transmission characteristics of the optical fiber, wherein each of the pump sources provides pump energy at a respective pump wavelength that differs from the signal wavelength by one or more Stokes shifts.

58. A first link according to claim 57 coupled to a second link in the optical transmission system, wherein one of the pump sources is also coupled to the second link and provides pump energy thereto.

59. A first link according to claim 58 wherein the pump source that is also coupled to the second link provides pump energy at a first pump wavelength to the first link and provides pump energy to the second link at a second pump wavelength that differs from the first pump wavelength.

60. A link according to claim 56 comprising a control circuit that selects a pump source from a plurality of pump sources to provide pump energy to the optical fiber, wherein the plurality of pump sources provide pump energy at different wavelengths that all differ from the signal wavelength by the same number of Stokes shifts.

61. A link according to claim 56 wherein transmission losses of the optical fiber are substantially minimized for the pump wavelength that differs from the signal wavelength by one Stokes shift.

62. A link according to claim 56 comprising one or more reflectors in the optical fiber that reflect energy at one or more of the pump wavelengths.

63. A link according to claim 56 comprising at least one pair of reflectors in the optical fiber, wherein a respective pair of reflectors reflects energy at a respective pump wavelength.

64. A link according to claim 63 wherein the respective pump wavelength is the second Raman order relative to the signal wavelength.

65. A link according to claim 63 comprising one reflector of a pair is in the coupling fiber between the pump source to the fiber for coupling pump light from the pump source to the fiber.

66. A link according to claim 63 comprising one reflector of a pair is in the fiber downstream from a point of optical coupling of the pump light from the pump source to the fiber.

67. A link according to claim 63 wherein said reflectors are fiber Bragg gratings.

68. A link according to claim 56 comprising a plurality of the pump sources that provide pump energy at substantially the same wavelength.

69. A link according to claim 56 comprising a plurality of the pump sources coupled to the optical fiber at a plurality of locations distributed along the length of the optical fiber.

70. A link according to claim 69 comprising one or more gratings formed in the optical fiber that distributively couple the plurality of pump sources.

71. A link according to claim 56 wherein the optical fiber maintains polarization orientation of the optical signal and pump the energy, and wherein pump energy from one pump source is coupled into the optical fiber such that the polarization orientation of the pump energy is substantially orthogonal to the polarization orientation of the optical signal.

72. A link according to claim 71 wherein the pump source is coupled to the optical fiber at a location separated from the optical fiber center by no more than twenty-five per cent of the optical fiber length.

73. A link according to claim 56 comprising a control circuit that varies the pump energy amplitude provided by one or more of the pump sources.

74. A link according to claim 73 wherein the control circuit causes pump energy to vary.

75. A link according to claim 73 wherein the control circuit varies pump energy to compensate for variations in operational characteristics caused by aging of the fiber.

76. A link according to claim 56 wherein the respective pump wavelengths of the one or more pump sources is shorter than the signal wavelength.

77. A link according to claim 56 comprising ions of a rare-earth dopant disposed within the optical fiber, wherein the dopant ions are pumped by the pump energy provided by the one or more pump sources.

78. A link according to claim 56 comprising a plurality of the pump sources that provide pump energy at substantially different wavelengths.

79. A link according to claim 56 comprising a control circuit coupled to one or more of the pump sources to control pump energy level, thereby controlling the optical transmission characteristics of the optical fiber.

80. A link according to claim 79 wherein the control circuit is coupled to a detector that detects levels of the optical signal proximate to the first end, whereby optical gain of the optical fiber is controlled in response to the optical signal level.

81. A link according to claim 80 wherein the control circuit is coupled to a pump source proximate to the first end.

82. A link according to claim 80 wherein the control circuit is coupled to a pump source proximate to the second end.

83. A link according to claim 56 comprising a first pump source that provides pump energy propagating toward the first end at a first pump wavelength and a second pump source that provides pump energy propagating toward the second end at a second pump wavelength, wherein the first pump wavelength differs from the signal wavelength by a first number of Stokes shifts and the second pump wavelength differs from the signal wavelength by a second number of Stokes shifts.

84. A link according to claim 83 comprising one or more additional pump sources that provide pump energy at respective pump wavelengths that differ from the signal wavelength by one or more Stokes shifts.

85. A link according to claim 83 wherein the first number of Stokes shifts differs from the second number of Stokes shifts.

86. A link according to claim 56 wherein the optical transmission characteristics of the optical fiber are such that chromatic dispersion characteristics vary along the length of the optical fiber.

87. A link according to claim 86 wherein the optical fiber comprises one or more first segments having a first chromatic dispersion characteristic and one or more second segments having a second chromatic dispersion characteristic that compensates for the first chromatic dispersion characteristic, and wherein the one or more second segments provide optical gain.

88. A link according to claim 87 wherein the one or more second segments are arranged proximate to the optical fiber center.

89. A link according to claim 56 wherein the optical transmission characteristics of the optical fiber are such that distributed optical gain is maximized and four-wave mixing is minimized.

90. A link according to claim 89 wherein the optical transmission characteristics vary along the length of the optical fiber.

91. A link according to claim 90 wherein the optical fiber comprises a silica-glass host in which germanium ions are disposed according to a density that varies along the length of the optical fiber.

92. A link according to claim 89 wherein the optical signal is substantially confined to a first region of the optical fiber and the pump energy is substantially confined to a second region of the optical fiber that is optically proximate to the first region.

93. A link according to claim 89 wherein the optical fiber comprises a first segment of fiber adjacent to the first end, a second segment of fiber adjacent to the second end, and a third segment of fiber between the first and second segments of fiber, and wherein the distributed optical gain of the optical fiber in the third segment is higher than the distributed optical gains of the first and second segments.

94. The optical fiber link of claim 56 wherein said pump source comprises two pump sources of first and second Raman order relative to said signal wavelength or bandwidth, said first Raman order pump source is counter propagating its light along the fiber and said second Raman order pump source is co-propagating its light along the fiber so that the Raman gain achieved in the fiber for said optical signal or signals via said first Raman order pump light is extended a greater distance in the fiber toward said second Raman order pump source.

95. The optical fiber link of claim 56 wherein said pump source comprises two pump sources of first and second Raman order relative to said signal wavelength or bandwidth, said first Raman order pump source is counter propagating its light along the fiber and said second Raman order pump source is counter propagating its light along the fiber so that the Raman gain achieved in the fiber for said optical signals via said first Raman order pump light is extended a greater distance into the fiber because of energy transfer from the second Raman order pump to the first Raman order pump.

96. The optical fiber link of claim 95 wherein pump power of said second Raman order pump is maintian at a higher level than pump power of first Raman order pump, the pump power of said second Raman order pump varied to change the point of peak Raman gain provided by said first Raman order pump in said fiber link.
